(19) United States
(12) Patent Application Publication
(10) Pub. No.: US 2026/0342434 A1
(43) Pub. Date: Oct. 29, 2026

(54) COMMUNICATION CONTROL METHOD AND COMMUNICATION DEVICE

(71) Applicant: Beijing Xiaomi Mobile Software Co., Ltd., Beijing (CN)

(72) Inventor: Yuxin MAO, Beijing (CN)

(73) Assignee: Beijing Xiaomi Mobile Software Co., Ltd., Beijing (CN)

(21) Appl. No.: 19/104,828

(22) PCT Filed: Aug. 22, 2022
(86) PCT No.: PCT/CN2022/114067

§ 371 Date: Feb. 19, 2025

(51) Int. Cl. H04B 7/185; H04L 5/00; H04W 60/06; H04W 76/25; H04W 76/30

(52) U.S. Cl. CPC H04B 7/18589; H04L 5/0053; H04W 60/06; H04W 76/25; H04W 76/30

(57) ABSTRACT

A communication control method including: obtaining feeder link information in a case where a feeder link is about to be disconnected; and sending the feeder link information to a user equipment (UE) through an access network device, where the feeder link information is configured to determine whether the UE continues to reside in a current network or accesses another network.

### CROSS-REFERENCE TO RELATED APPLICATIONS

The present application is a U.S. National Stage of International Application No. PCT/CN2022/114067, entitled “COMMUNICATION CONTROL METHOD, SYSTEM AND APPARATUS, COMMUNICATION DEVICE AND STORAGE MEDIUM”, filed on Aug. 22, 2022, the contents of all of which are incorporated herein by reference in their entireties for all purposes.

### BACKGROUND OF THE INVENTION

When a user equipment (UE) is connected to a core network (CN) device through an access network (AN) device such as a base station (gNB), for example, when the access network is composed of a satellite, a ground receiving station and gNB functions, since the satellite may not always maintain a connection with the ground station, that is, a feeder link connection, a feeder link may be disconnected, resulting in abnormal access of the UE or abnormal service operation of the UE.

### SUMMARY OF THE INVENTION

The present disclosure relates to, but not limited to, the technical field of wireless communications, and in particular, to a communication control method and a communication device.

According to a first aspect of the embodiments of the present disclosure, a communication control method is provided. The method is performed by a first core network device and includes: obtaining feeder link information, in a case where a feeder link is about to be disconnected; and sending the feeder link information to a user equipment (UE) through an access network device, where the feeder link information is configured to determine whether the UE continues to reside in a current network or accesses another network.

According to a second aspect of the embodiments of the present disclosure, a communication control method is provided. The method is performed by a UE and includes:
receiving feeder link information, in a case where a feeder link is about to be disconnected; and determining, according to the feeder link information, whether to continue to reside in a current network or access another network.

According to a third aspect of the embodiments of the present disclosure, a communication control method is provided. The method is performed by an access network device and includes: sending feeder link information, in response to detecting that a feeder link is about to be disconnected, where the feeder link information is configured to determine whether a UE continues to reside in a current network or accesses another network.

According to a fourth aspect of the embodiments of the present disclosure, a communication device is provided. The device includes: one or more processors; a memory that stores an executable program that is runnable by the one or more processors, where the one or more processors are collectively configured to, when running the executable program, perform the communication control method provided in the aforementioned first aspect.

It is to be understood that both the foregoing general description and the following detailed description are example and explanatory, and are not intended to limit the embodiments of the present disclosure.

### BRIEF DESCRIPTION OF DRAWINGS

The accompanying drawings herein are incorporated in and constitute a part of this specification, illustrate embodiments consistent with the present disclosure, and serve to explain the principles of the embodiments of the present disclosure together with the specification.

FIG. 1 is a structural schematic diagram of a wireless communication system according to an example.

FIG. 2 is a schematic flowchart of a communication control method according to an example.

FIG. 3 is a structural schematic diagram of a communication control system according to an example.

FIG. 4 is a schematic flowchart of a communication control method according to an example.

FIG. 5 is a schematic flowchart of a communication control method according to an example.

FIG. 6 is a schematic flowchart of a communication control method according to an example.

FIG. 7 is a schematic flowchart of a communication control method according to an example.

FIG. 8 is a schematic flowchart of a communication control method according to an example.

FIG. 9 is a schematic flowchart of a communication control method according to an example.

FIG. 10 is a schematic flowchart of a communication control method according to an example.

FIG. 11 is a structural schematic diagram of a first communication control device according to an example.

FIG. 12 is a structural schematic diagram of a second communication control device according to an example.

FIG. 13 is a structural schematic diagram of a third communication control device according to an example.

FIG. 14 is a block diagram of a second terminal according to an example.

FIG. 15 is a structural schematic diagram of a communication device according to an example.

### DETAILED DESCRIPTION OF THE INVENTION

In the related art, in a scenario where the feeder link is disconnected, a unified handling method is often used for all associated users, such as disconnecting the communication of all associated users or maintaining the communication of all associated users. However, this method to handle feeder link disconnection is not flexible enough, which often leads to a large amount of data caches and the increase of network overhead or service interruption, affecting the service experience.

Embodiments of the present disclosure provide a communication control method and a communication device.

Examples will be described in detail herein, examples of which are shown in the accompanying drawings. When the following description relates to the accompanying drawings, the same numerals in different accompanying drawings represent the same or similar elements, unless otherwise indicated. The implementations described in the following examples do not represent all implementations consistent with the present disclosure. Rather, they are examples of the device and the method consistent with some aspects of the embodiments of the present disclosure.

The terms used in the embodiments of the present disclosure are for the purpose of illustrating specific embodiments, and are not intended to limit the embodiments of the present disclosure. The terms “a/an”, “said” and “the” of singular forms used in the present disclosure are also intended to include plural forms, unless otherwise specified in the context clearly. It is also to be understood that the term “and/or” used herein indicates and includes any or all possible combinations of one or more associated listed items.

It is to be understood that although the terms first, second, third, etc. may be used to describe various information in the embodiments of the present disclosure, these information may not be limited by these terms. These terms are used to distinguish the same type of information from each other. For example, without departing from the scope of the embodiments of the present disclosure, first information may be referred to as second information, and similarly, the second information may be referred to as the first information. Depending on the context, the word “if” as used herein may be interpreted as “at the time of” or “when” or “in response to determining”.

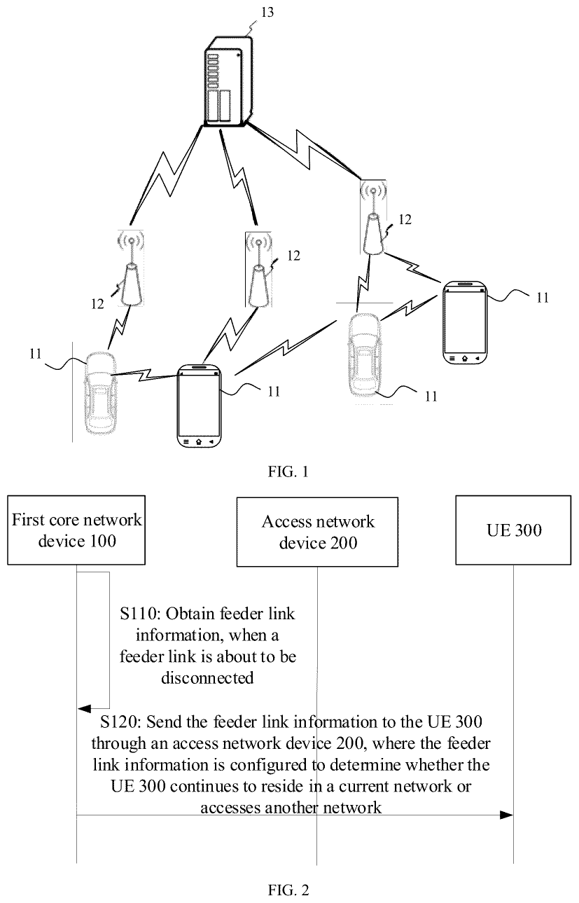

Reference is made to FIG. 1, which shows a structural schematic diagram of a wireless communication system provided in the embodiments of the present disclosure. As shown in FIG. 1, the wireless communication system is a communication system based on cellular mobile communication technology, and may include a plurality of first terminals 11 and a plurality of access devices 12.

The first terminal 11 may refer to a device providing voice and/or data connectivity for a user. The first terminal 11 may be in communication with one or more core networks via a radio access network (RAN). The first terminal 11 may be an Internet of Things terminal, such as a sensor device, a mobile phone (also known as a “cellular” phone) and a computer with an Internet of Things terminal. For example, the first terminal 11 may be a fixed, portable, pocket-sized, hand-held, computer built-in or vehicle-mounted device, such as a station (STA), a subscriber unit, a subscriber station, a mobile station, a mobile, a remote station, an access point, a remote terminal, an access terminal, a user terminal, a user agent, a user device, or a user equipment (terminal). Alternatively, the first terminal 11 may be a device of an unmanned aerial vehicle. Alternatively, the first terminal 11 may also be a vehicle-mounted device, such as a trip computer with a wireless communication function, or a wireless communication device externally connected to the trip computer. Alternatively, the first terminal 11 may also be a roadside device, such as a street lamp, signal lamp or other roadside device with the wireless communication function.

The access device 12 may be a network-side device in a wireless communication system. The wireless communication system may be the 4th generation mobile communication (4G) system, also known as a long term evolution (LTE) system. Alternatively, the wireless communication system may also be a 5G system, also known as a new radio (NR) system or a 5G NR system. Alternatively, the wireless communication system may also be a next generation system of the 5G system, where an access network in the 5G system may be called a new generation-radio access network (NG-RAN). Alternatively, the wireless communication system may also be an MTC system.

The access device 12 may be an evolved access device (eNB) adopted in the 4G system. Alternatively, the access device 12 may also be an access device (gNB) adopting a centralized distributed architecture in the 5G system. When adopting the centralized distributed architecture, the access device 12 generally includes a central unit (CU) and at least two distributed units (DUs). Protocol stacks of a packet data convergence protocol (PDCP) layer, a radio link control protocol (RLC) layer and a median access control (MAC) layer are provided in the central unit; and a protocol stack of a physical (PHY) layer is provided in the distributed unit. The specific implementation of the access device 12 is not limited in the embodiments of the present disclosure.

A wireless connection may be established between the access device 12 and the first terminal 11 through a wireless air interface. In different implementations, the wireless air interface may be a wireless air interface based on the 4th generation mobile communication network technology (4G) standard; alternatively, the wireless air interface may be a wireless air interface based on the 5th generation mobile communication network technology (5G) standard, for example, the wireless interface may be a new radio; alternatively, the wireless air interface may also be a wireless air interface based on the next generation mobile communication network technology standard of 5G.

In some examples, the wireless communication system may further include a network management device 13. The plurality of access devices 12 are respectively connected to the network management device 13. The network management device 13 may be a core network device in the wireless communication system. For example, the network management device 13 may be a mobility management entity (MME) in an evolved packet core (EPC). Alternatively, the network management device may also be other core network device, such as a serving gateway (SGW), a public data network gateway (PGW), a policy and charging rules function (PCRF), or a home subscriber server (HSS). The implementation form of the network management device 13 is not limited in the embodiments of the present disclosure.

As shown in FIG. 2, an embodiment of the present disclosure provides a communication control method. The method is performed by a first core network device 100 and includes steps S110 and S120.

S110: feeder link information is obtained, when a feeder link is about to be disconnected.

S120: the feeder link information is sent to a UE 300 through an access network device 200, where the feeder link information is configured to determine whether the UE 300 continues to reside in a current network or accesses another network.

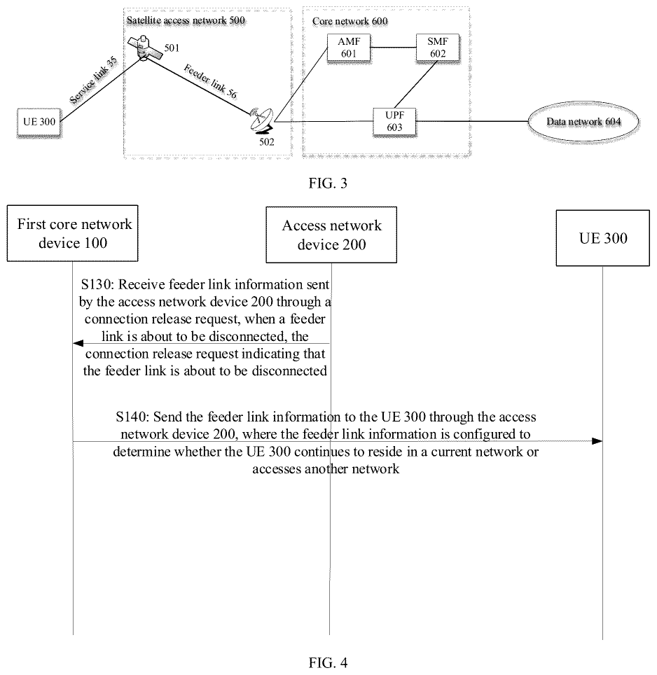

In the embodiments of the present disclosure, as shown in FIG. 3, a satellite access network 500 may include a plurality of access devices, such as satellites 501 equipped with base station (gNodeB, gNB) functions or some functions, and ground receiving stations 502. The core network 600 may be connected to the ground receiving station 502 for establishing a connection with the satellite 501 through the ground receiving station 502. The core network 600 may include a plurality of core network devices, such as an access and mobility management function (AMF) 601, a user plane function (UPF) 603, and a session management function (SMF) 602, where the first core network device 100 may be an AMF, and the UPF 603 communicates with data network 604. The feeder link 56 may be a connection link between the satellite 501 equipped with gNB functions or some functions and the ground receiving station 502, and a service link 35 may be a connection link between the satellite 501 equipped with gNB functions or some functions and the UE 300.

In one embodiment, the feeder link information may indicate at least one a state of a feeder link, a parameter, a state of an access network device to which the feeder link is connected, a working parameter, or the like. For example, the feeder link information may be configured to determine at least one of the following information: establishment time, establishment duration, disconnection time and disconnection duration of the feeder link.

In one embodiment, the disconnection time and/or the disconnection duration of the feeder link may be determined according to the establishment time and/or the establishment duration of the feeder link. For example, the disconnection duration of the feeder link may be determined based on the establishment time and the establishment duration of the feeder link and a historical disconnection situation of the feeder link.

In one embodiment, that a feeder link is about to be disconnected may be detecting or receiving a message indicating that the feeder link is about to be disconnected sent by an access network device, for example, it may be a broadcast messages carrying content indicating that the feeder link is about to be disconnected sent by the access network device, etc.

In one embodiment, obtaining feeder link information, when a feeder link is about to be disconnected may include: receiving the feeder link information sent by the access network device, when receiving a notification indicating that the feeder link is about to be disconnected. The notification indicating that the feeder link is about to be disconnected may be sent by the access network device to the first core network device when detecting that the feeder link is about to be disconnected.

In one embodiment, the feeder link information may be carried in the notification indicating that the feeder link is about to be disconnected. For example, the feeder link information sent by the access network device is obtained from the notification, when receiving the notification indicating that the feeder link is about to be disconnected.

In one embodiment, the feeder link information is used for the UE to decide whether to continue to reside in the current network when the feeder link is about to be disconnected. For example, continuing to reside in the current network may include maintaining a radio resource control (RRC) connection between the UE and the access network device, and may further include caching, by the access network device, a second core network device or a third core network device, transmission data associated with the UE. The second core network device may be an SMF, and the third core network device may be a UPF.

In one embodiment, not continuing to reside in the current network may be accessing another network. For example, accessing another network may include: initiating a deregistration request to the first core network device of the current network, completing deregistration through a current satellite network, and selecting another available network to initiate registration; alternatively, accessing another network may also include: directly switching to another available network.

In one embodiment, sending the feeder link information to the UE may include: sending the feeder link disconnection duration indicated by the feeder link information to the UE, where the feeder link disconnection duration is configured to determine whether the UE continues to reside in the current network or accesses another network. For example, the feeder link disconnection duration may be used in conjunction with a current service type of the UE to determine whether the UE continues to reside in the current network or accesses another network.

By way of example, if the service currently carried out by the UE is a non-real-time service, for example, the maximum time delay allowed by the type of this service is greater than the feeder link disconnection duration, it may be determined that the UE continues to reside in the current network; and if the service currently carried out by the UE is a real-time service, for example, the type of this service may be determined that the UE selects to access another network when the feeder link is disconnected.

In this way, by sending the feeder link information to the UE, the UE may decide, in a scenario where the feeder link is disconnected, whether to continue to reside in the network or select to access another network to disconnect the communication in the current network, so that the possibilities that the UE cannot decide whether to continue the communication according to its own needs but the UE can decide whether to continue to reside in the current network based on the feeder link information due to the fact that a network-side device controls the communication of the UE may be reduced, improving the flexibility of communication control, and reducing poor communication flexibility caused by adopting a single control strategy for a plurality of UEs, reducing network overhead.

In one embodiment, obtaining the feeder link information may include: querying feeder link information corresponding to an access network device associated with the UE. For example, the feeder link information may be obtained from an access network device, or the feeder link information may be obtained from a ground receiving station or a server.

In some embodiments, obtaining the feeder link information may include: receiving the feeder link information sent by the access network device.

The feeder link information sent by the access network device may be feeder link information sent by the access network device separately, or may also be feeder link information carried in a request or a message sent by the access network device.

As shown in FIG. 4, an embodiment of the present disclosure provides a communication control method. The method is performed by a first core network device 100 and includes steps S130 and S140.

S130: the feeder link information sent by the access network device 200 through a connection release request is received, when the feeder link is about to be disconnected, the connection release request indicating that the feeder link is about to be disconnected.

S140: the feeder link information is sent to the UE 300 through the access network device 200, where the feeder link information is configured to determine whether the UE 300 continues to reside in a current network or accesses another network.

In the embodiments of the present disclosure, the connection release request may be configured to request to release a connection between the access network device and the first core network device, for example, to request to release an N2 connection. The connection release request may be a request sent by the access network device when detecting that the feeder link is about to be disconnected. In this way, a communication connection between the access network device and the core network device may be rapidly released when the feeder link is disconnected.

In one embodiment, the connection release request may request to release UE context saved in the access network device. The access network device may release the UE context when the first core network device returns a connection release instruction to the access network device in response to the connection release request, releasing the N2 connection between the first core network device associated with the UE corresponding to the UE context and the access network device.

In one embodiment, the connection release request may carry a cause value, where the cause value may indicate a cause for requesting to release the N2 connection. The connection release request indicating that the feeder link is about to be disconnected may be the cause value carried in the connection release request indicating that the release of the N2 connection is triggered by feeder link disconnection.

In one embodiment, a connection release cause value may be a cause identifier that has a mapping relationship with a connection release cause. For example, the connection release cause value may include numerical values of one or more bits, and different cause values correspond to different connection release causes.

In one embodiment, the connection release request may carry feeder link information, for example, the carried feeder link information may be associated with a feeder link that is about to be disconnected indicated by a cause value.

In this way, by carrying the feeder link information in the connection release request, the network overhead caused by sending the feeder link information to the first core network device separately may be reduced, and an association with the connection release request may be established, which is beneficial to quickly determining the feeder link that is about to be disconnected.

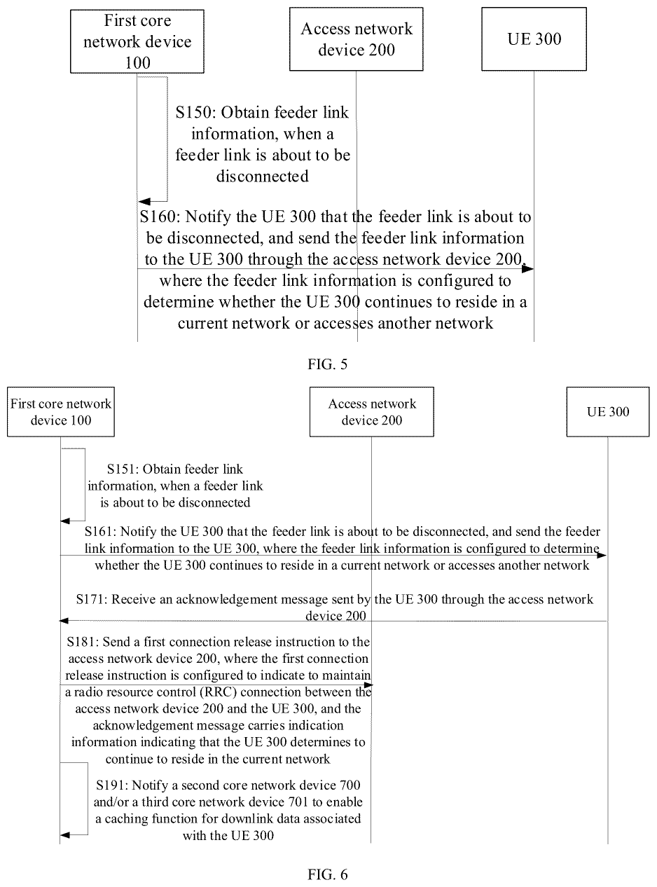

As shown in FIG. 5, an embodiment of the present disclosure provides a communication control method. The method is performed by a first core network device 100 and includes steps S150 and S160.

S150: feeder link information is obtained, when a feeder link is about to be disconnected.

S160: a UE 300 is notified that the feeder link is about to be disconnected, and the feeder link information is sent to the UE 300 through an access network device 200, where the feeder link information is configured to determine whether the UE 300 continues to reside in a current network or accesses another network.

In the embodiments of the present disclosure, notifying the UE that the feeder link is about to be disconnected may be sending to the UE a notification message indicating that the feeder link is about to be disconnected. For example, a notification message indicating that the feeder link is about to be disconnected may be sent to the UE through a UE configuration update (UCU) program or a UE parameter update (UPU) program.

In some embodiments, notifying the UE that the feeder link is about to be disconnected may include: generating a notification message according to the UCU program or the UPU program, where the notification message is configured to indicate that the feeder link is about to be disconnected; and sending the notification message to the UE through the access network device.

In one embodiment, the feeder link information may be sent to the UE by being carried in a notification message, or may be sent to the UE separately from the notification message. For example, the feeder link information may be carried in the notification message and bound with identification information about the feeder link that is about to be disconnected indicated by the notification message.

In one embodiment, the notification message may carry an event identifier, where the event identifier may indicate that a current event is that the feeder link is about to be disconnected. By way of example, the event identifier may be a flag bit composed of one or more bits, or the like. The event identifier may have a binding relationship with event, and different event identifiers indicate different events.

In this way, by notifying the UE that the feeder link is about to be disconnected, it can be beneficial for the UE to quickly know a currently occurring feeder link disconnection event, improving the efficiency of the UE in deciding whether to continue to reside in the current network and the network-side device in performing a control operation.

As shown in FIG. 6, an embodiment of the present disclosure provides a communication control method. The method is performed by a first core network device 100 and includes steps S151, S161, S171, S181, and S191.

S151: feeder link information is obtained, when a feeder link is about to be disconnected.

S161: a UE 300 is notified that the feeder link is about to be disconnected, and the feeder link information is sent to the UE 300, where the feeder link information is configured to determine whether the UE 300 continues to reside in a current network or accesses another network.

S171: an acknowledgement message sent by the UE 300 is received through an access network device 200.

S181: a first connection release instruction is sent to the access network device 200, where the first connection release instruction is configured to indicate to maintain an RRC connection between the access network device 200 and the UE 300, and the acknowledgement message carries indication information indicating that the UE 300 determines to continue to reside in the current network.

S191: a second core network device 700 and/or a third core network device 701 are notified to enable a caching function for downlink data associated with the UE 300.

In the embodiments of the present disclosure, the acknowledgement message sent by the UE may be an acknowledgement message indicating that the UE successfully receives the notification message, which is sent by the UE in response to the notification message sent by the first core network device. For example, when sending the notification message through the UCU program or the UPU program, the first core network device may also receive the acknowledgement message returned by the UE through the UCU program or the UPU program.

In one embodiment, when receiving indication information carried in the acknowledgement message, the first core network device may determine that the UE selects to continue to reside in the current network, where the indication information may be information such as an instruction indicating that the UE determines to continue to reside in the current network. In this case, a control operation related to that the UE continues to reside in the current network may be performed.

In one embodiment, feeder link information may be feeder link information sent by the access network device through a connection release request. After determining, based on the indication information carried in the acknowledgement message, that the UE continues to reside in the current network, a first connection release instruction may be sent to the access network device, where the first connection release instruction may be configured to indicate the access network device to release an N2 connection with the first core network device and maintain an RRC connection between the access network device and the UE.

Since the UE continues to reside in the current network, after the feeder link is disconnected, the access network device may still cache uplink transmission data associated with the UE, so that it is still need to maintain the RRC connection, maintaining the capability of data communication between the access network device and the UE. Indicating the access network device to release the N2 connection may be indicating the access network device to release the UE context, etc.

In one embodiment, the first connection release instruction may be further configured to indicate to release an N3 connection between the access network device and the third core network device such as the UPF.

In one embodiment, enabling a caching function for downlink data associated with the UE may be caching downlink data to be transmitted associated with the UE when the feeder link is disconnected. For example, when the feeder link is disconnected, the downlink data is cached as the core network device such as the UPF receives downlink data associated with the UE, and the cached downlink data is sent to the UE through the access network after the feeder link is reconnected.

Here, the downlink data associated with the UE may be data sent by the network to the UE.

In one embodiment, the caching function for the downlink data associated with the UE may be performed by the SMF and/or the UPF.

In this way, when it is determined that the UE continues to reside in the current network, it is guaranteed that the downlink data associated with the UE is cached in the case where the feeder link is disconnected by indicating to release the N2 connection and maintain the RRC connection, and forwarding is continued after the feeder link is reconnected.

In some embodiments, the method may further include: receiving an acknowledgement message sent by the UE through the access network device; performing deregistration on the UE based on a received deregistration request of the UE, where the acknowledgement message does not carry indication information indicating that the UE determines to continue to reside in the current network; sending a second connection release instruction to the access network device, where the second connection release instruction is configured to indicate to release the RRC connection between the access network device and the UE; releasing a connection with the second core network device; and notifying the second core network device and the third core network device to release a connection between the second core network device and the third core network device.

In the embodiments of the present disclosure, if the acknowledgement message does not carry the indication information, and is, for example, merely configured to indicate that the UE successfully receives the notification message, it is indicated that the UE does not continue to reside in the current network. For example, it is indicated that the UE needs to perform deregistration and select to access another available network, or needs to switch to another available network.

In one embodiment, after receiving a deregistration request of the UE, the first core network device processes the received deregistration request, for example, performs deregistration on the UE based on the deregistration request, where performing deregistration may be releasing the UE context, etc. saved in the first core network device.

In one embodiment, based on the received deregistration request of the UE, the second connection release instruction sent to the access network device indicates the access network device to release the N2 connection and release the RRC connection between the access network device and the UE.

Here, since the UE no longer continues to reside in the current network, after the feeder link is disconnected, the access network device does not need to cache and forward the transmission data associated with the UE, so that it is unnecessary to continue to maintain the RRC connection, indicating to release the RRC connection. Indicating the access network device to release the N2 connection may be indicating the access network device to release the saved UE context, etc.

In one embodiment, the second connection release instruction may be further configured to indicate to release of an N3 connection between the access network device and the third core network device such as the UPF.

In one embodiment, releasing a connection with the second core network device and notifying the second core network device and the third core network device to release a connection between the second core network device and the third core network device may include: releasing a connection between the first core network device and the second core network device, for example, releasing a connection between the AMF and the SMF, and notifying the second core network device and the third core network device to release a connection between the second core network device and the third core network device, for example, notifying the SMF and the UPF to release an N4 connection between the SMF and the UPF.

In some embodiments, the first core network device is an access and mobility management function (AMF), the second core network device is a session management function (SMF), and the third core network device is a user plane function (UPF).

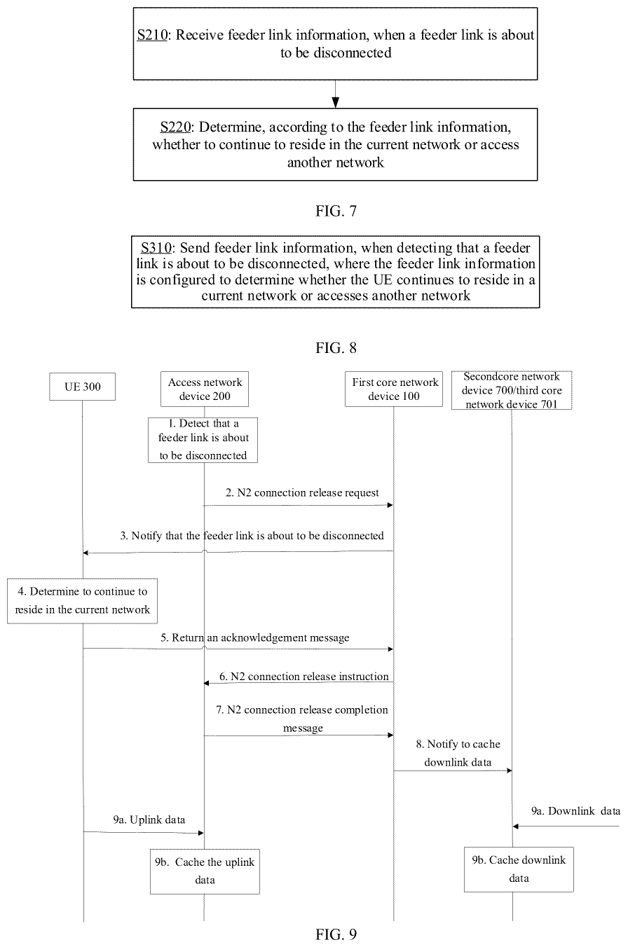

As shown in FIG. 7, an embodiment of the present disclosure provides a communication control method. The method is performed by a UE and includes steps S210 and S220.

S210, feeder link information is received, when a feeder link is about to be disconnected.

S220, whether to continue to reside in the current network or access another network, according to the feeder link information, is determined.

In the embodiments of the present disclosure, the feeder link information may indicate at least one of a state of a feeder link, a parameter, a state of an access network device to which the feeder link is connected, a working parameter, or the like. For example, the feeder link information may be configured to determine at least one of the following information: establishment time, establishment duration, disconnection time and disconnection duration of the feeder link.

In one embodiment, the feeder link information may be feeder link information sent by a first core network device and received through an access network device, such as feeder link information carried in a notification message sent by the first core network device and received through the access network device, where the notification message may be configured to indicate that the feeder link is about to be disconnected.

In one embodiment, the disconnection time and/or the disconnection duration of the feeder link may be determined according to the establishment time and/or the establishment duration of the feeder link. For example, the disconnection duration of the feeder link may be determined based on the establishment time and the establishment duration of the feeder link and a historical disconnection situation of the feeder link.

In one embodiment, the feeder link being about to be disconnected may be detecting or receiving a notification message indicating that the feeder link is about to be disconnected sent by the first core network device. For example, the notification message may be a notification message sent through a UCU program or the UPU program, or the like.

In one embodiment, the feeder link information may be carried in a notification indicating that the feeder link is about to be disconnected. For example, the feeder link information sent by the access network device is obtained from the notification message, when receiving the notification message indicating that the feeder link is about to be disconnected.

In one embodiment, the feeder link information is used for the UE to decide whether to continue to reside in the current network when the feeder link is about to be disconnected. For example, continuing to reside in the current network may include maintaining an RRC connection between the UE and the access network device, and may further include caching, by the access network device, a second core network device or a third core network device, transmission data associated with the UE, where the second core network device may be an SMF, and the third core network device can be a UPF.

In one embodiment, accessing another network may be initiating a deregistration request to the first core network device corresponding to the current network, completing deregistration through a current satellite access network, and selecting another available network to initiate registration, or accessing another network may also be switching to another available network.

In this way, by receiving the feeder link information, the UE may decide, in a scenario where the feeder link is disconnected, to continue to reside in the network or select to access another available network to disconnect the communication in the current network, so that the possibilities that the UE cannot decide whether to continue the communication according to its own needs but the UE can decide whether to continue to reside in the current network based on the feeder link information due to the fact that a network-side device controls the communication of the UE may be reduced, improving the flexibility of communication control reducing poor communication flexibility caused by adopting a single control strategy for a plurality of UEs, and reducing network overhead.

In some embodiments, determining, according to the feeder link information, whether to continue to reside in the current network or access another network includes: obtaining a feeder link disconnection duration indicated by the feeder link information when receiving the feeder link information sent by a first core network device through a access network device; and determining, according to the feeder link disconnection duration and a current service type of the UE, whether the UE continues to reside in the current network or accesses another network.

In the embodiments of the present disclosure, the feeder link disconnection duration may be indicated by the feeder link information sent by the first core network device or may be directly sent by the first core network device.

In one embodiment, determining, according to the feeder link disconnection duration and a current service type of the UE, whether the UE continues to reside in the current network or accesses another network may be determining, according to the feeder link disconnection duration and the type of a service currently carried out by the UE, whether the UE continues to reside in the current network or accesses another network.

In one embodiment, if the service currently carried out by the UE is a non-real-time service, it may be determined that the UE continues to reside in the current network; and if the service currently carried out by the UE is a real-time service, it may be determined that UE selects to access another network.

In one embodiment, if the maximum time delay allowed by the current service type of the UE is greater than a first threshold and the feeder link disconnection duration is less than the maximum time delay, it may be determined that the UE continues to reside in the current network; and if the maximum time delay allowed by the current service type of the UE is less than or equal to the first threshold, and/or the feeder link disconnection duration is greater than or equal to a second threshold, it may be determined that the UE selects to access another network, where the second threshold is greater than the first threshold.

In one embodiment, determining, according to the feeder link disconnection duration and a current service type of the UE, whether the UE continues to reside in the current network or accesses another network may include: determining, according to the feeder link disconnection duration and the current service type of the UE and the type of the UE, whether the UE continues to reside in the current network or accesses another network.

In some embodiments, the method may further include: receiving a notification message sent by the first core network device through the access network device, where the notification message is configured to indicate that the feeder link is about to be disconnected; and returning an acknowledgement message carrying the indication information indicating that the UE determines to continue to reside in the current network through the access network device, when it is determined that the UE continues to reside in the current network.

In the embodiments of the present disclosure, the acknowledgement message returned by the UE may be an acknowledgement message indicating that the UE successfully receives the notification message, which is returned by the UE in response to the notification message sent by the first core network device. For example, when sending the notification message through a UCU program or a UPU program, the first core network device may also receive the acknowledgement message returned by the UE through the UCU program or the UPU program.

In one embodiment, when the UE determines to continue to reside in the current network, the returned acknowledgement message may carry indication information, where the indication information may be information such as an instruction indicating that the UE determines to continue to reside in the current network, and in this case, may be configured to indicate the first core network device to perform a control operation related to that the UE continues to reside in the current network.

In some embodiments, the method may further include: receiving a notification message sent by the first core network device through the access network device, where the notification message is configured to indicate that the feeder link is about to be disconnected; returning an acknowledgement message through the access network device and sending a deregistration request to the first core network device, when it is determined that the UE selects to access another network; and selecting a radio access network and a core network that support access of the UE and initiating registration, when a deregistration is completed.

In one embodiment, when the UE determines to access another network, the returned acknowledgement message may not carry the indication information, for example, the acknowledgement message is merely configured to indicate that the UE successfully receives the notification message.

In one embodiment, when the UE determines to access another network, the returned acknowledgement message may carry the indication information indicating accessing another network, for example, indicating that the UE selects to access another network, etc., and in this case, may be configured to indicate the first core network device to perform a control operation related to that the UE selects to access another network.

In some embodiments, the method may further include: receiving a notification message sent by the first core network device through the access network device, where the notification message is configured to indicate that the feeder link is about to be disconnected; and switching to a radio access network and a core network that support UE access and are different from a current satellite access network, when it is determined that the UE selects to access another network.

Here, switching to a radio access network and a core network that support UE access and are different from the current access network may be sending UE context information to other radio access network and core network that are different from the current network, and switching to a connection of other radio access network and core network.

In some embodiments, the feeder link information received by the UE may also be feeder link information sent by the access network device through a broadcast message, or feeder link information indicated in a feeder link disconnection event notified by the access network device through a broadcast message.

As shown in FIG. 8, an embodiment of the present disclosure provides a communication control method. The method is performed by an access network device and includes step S310.

S310, feeder link information is sent, when detecting that a feeder link is about to be disconnected, where the feeder link information is configured to determine whether a UE continues to reside in a current network or accesses another network.

In the embodiments of the present disclosure, the access network device may detect a state of the feeder link, for example, determine, based on state information about the feeder link, whether the feeder link is about to be disconnected; and send feeder link information when detecting that the feeder link is about to be disconnected, for example, send the feeder link information to the first core network device by carrying the feeder link information in an N2 connection release request.

In one embodiment, the access network device may send feeder link information to the UE through a broadcast message, for example, notify that the feeder link information is carried in the feeder link disconnection event through a broadcast message, or the like.

In one embodiment, the feeder link information may indicate at least one of a state of a feeder link, a parameter, a state of an access network device to which the feeder link is connected, a working parameter, or the like. For example, the feeder link information may be configured to determine at least one of the following information: establishment time, establishment duration, disconnection time and disconnection duration of the feeder link.

In one embodiment, the disconnection time and/or the disconnection duration of the feeder link may be determined according to the establishment time and/or the establishment duration of the feeder link, for example, the disconnection duration of the feeder link may be determined based on the establishment time and the establishment duration of the feeder link and a historical disconnection situation of the feeder link.

In some embodiments, sending the feeder link information to the first core network device may include: sending the feeder link information to the first core network device through a connection release request.

The method may further include: releasing an N2 connection with the first core network device and maintaining an RRC connection with the UE when a first connection release instruction sent by the first core network device is received, where the first connection release instruction is an instruction sent by the first core network device when the UE determines to continue to reside in the current network.

In some embodiments, the method may further include: caching uplink data associated with the UE, when the feeder link is disconnected; and sending the cached uplink data, when the feeder link is reconnected.

In the embodiments of the present disclosure, the access network device may cache the uplink data associated with the UE, when the feeder link is disconnected. For example, for uplink data transmitted by the UE, the access network device may cache the uplink data when the feeder link is disconnected, and re-sent the uplink data cached during disconnection when the feeder link is reconnected.

In one embodiment, the method may further include: discarding the cached uplink data associated with the UE, when the feeder link has not been reconnected after the feeder link disconnection duration indicated by the feeder link information from the time when the feeder link is disconnected.

In some embodiments, the method may further include: releasing the N2 connection with the first core network device and releasing the RRC connection with the UE when a second connection release instruction sent by the first core network device is received, where the second connection release instruction is an instruction sent by the first core network device when the UE determines to access another network.

An embodiment of the present disclosure provides a method for processing UE access in a discontinuous connection state of a feeder link. The method may include: a network device notifies a UE of a feeder link disconnection event through a notification message which may further include a feeder link disconnection duration. The network device may be an access network device, which may notify the disconnection event through a broadcast message or the like. Alternatively, the network device may also be a first core network device (such as an AMF), which receives a notification of the feeder link disconnection from the access network device, for example, the notification may further include feeder link information. The first core network device notifies the UE of the feeder link disconnection through a UCU program or a UPU program.

According to the notified feeder link disconnection event, the UE decides to continue to reside in the current network or deregister from the current access network, and selects and accesses other available networks.

Here, the decision process of the UE may also be based on terminal type and/or service type (such as time delay tolerance) and other information.

If selecting to continue to reside in the current network, the UE will normally carry out a service. During the feeder link disconnection, a network-side device (at least one of gNB, SMF and UPF) will cache service transmission data associated with the UE, and send the cached data when connection is restored.

Solution one, as shown in FIG. 9 includes steps 1-9.
1. An access network device 200 detects that a feeder link between a satellite and a ground station is about to be disconnected.
2. The access network device 200 initiates an N2 connection release request, which indicates that the feeder link is about to be disconnected, and at the same time, sends feeder link information or a disconnection duration to a first core network device 100.
3. The first core network device 100 initiates a UCU program to a UE 300, notifies the UE 300 that the feeder link is about to be disconnected, and sends the disconnection duration to the UE 300.
4. The UE 300 decides, according to the notification of the feeder link disconnection, the disconnection duration, the requirements of a service carried out by the UE 300 for time delay or the like, to continue to reside in the current network.
5. In a return message of the UCU program, the UE 300 indicates that the UE 300 still resides in the current network during the feeder link disconnection.
6. The first core network device 100 returns an N2 connection release instruction to the access network device 200. According to step 5, the returned N2 connection release instruction includes indication information of reserving an RRC connection.
7. The access network device 200 receives the N2 connection release instruction, and does not initiate RRC connection release if the indication information of reserving an RRC connection is carried. The access network device 200 releases N2 and N3 connections, and returns an N2 connection release completion message to the first core network device 100.
8. The first core network device 100 notifies an SMF 700 and/or a UPF 701 to cache downlink data.
9a and 9b. When the feeder link is disconnected, the access network device 200 caches the uplink data when uplink data sent by the UE 300 reaches the access network device 200; and the SMF 700 and/or the UPF 701 caches the downlink data when receiving downlink data of the UE 300. When the feeder link is reconnected, the access network device 200 sends the cached uplink data, and the SMF 700 and/or the UPF 701 sends the cached downlink data.

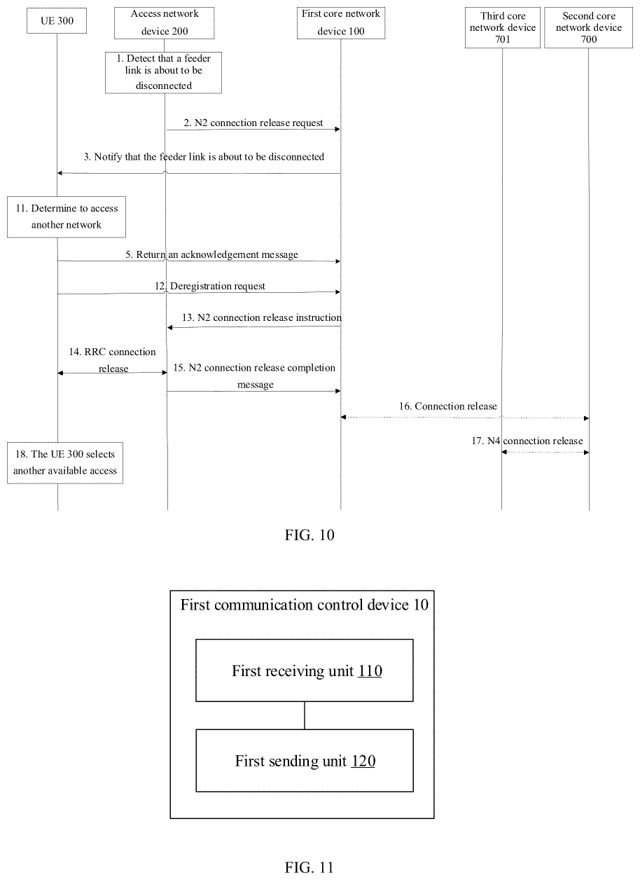

Solution two, as shown in FIG. 10 includes steps 1-3 and step 5 as shown and described with reference to FIG. 9, step 11 and steps 12-18.
1. An access network device 200 detects that a feeder link between a satellite and a ground station is about to be disconnected.
2. The access network device 200 initiates an N2 connection release request, which indicates that the feeder link is about to be disconnected, and at the same time, sends feeder link information or a disconnection duration to a first core network device 100.
3. The first core network device 100 initiates a UCU program to a UE 300, notifies the UE 300 that the feeder link is about to be disconnected, and sends the disconnection duration to the UE 300.
11. The UE 300 decides, according to the notification of the feeder link disconnection, the disconnection duration, the requirements of a service carried out by the UE 300 for time delay or the like, whether to access another network. If the service carried out by the UE 300 has high requirements for time delay, when the feeder link is disconnected, the UE 300 selects to deregister from the current network, and selects to access another available network for access and initiate registration.
5. The UE 300 sends a return acknowledgement message of the UCU.
12. The UE 300 initiates a deregistration request.
13. When receiving the deregistration request of the UE 300, the first core network device 100 processes the deregistration request, and sends an N2 connection release instruction to the access network device 200.
14. The access network device 200 initiates an RRC connection release process, if the N2 connection release instruction does not carry the indication information of reserving an RRC connection.
15. The access network device 200 releases N2 and N3 connections, and returns an N2 connection release completion message to the first core network device 100.
16-17. The AMF completes the release of a connection with the SMF 700, and the release of a connection between the SMF 700 and the UPF 701.
18. The UE 300 selects another available network to complete an access registration process.

An embodiment of the present disclosure provides a communication system. The communication system includes: a first core network device, a UE, and an access network device, where
the first core network device is configured to receive feeder link information sent by the access network device; and notify the UE that the feeder link is about to be disconnected, when a feeder link is about to be disconnected, and send the feeder link information to the UE through the access network device, where the feeder link information is configured to determine whether the UE continues to reside in the current network or accesses another network; the UE is configured to receive the feeder link information sent by the first core network device through the access network device, when the feeder link is about to be disconnected, and determine, according to the received feeder link information, whether to continue to reside in the current network or access another network; and the access network device is configured to send the feeder link information, when detecting that the feeder link is about to be disconnected.

In some embodiments, the first core network device is configured to receive feeder link information sent by the access network device through a connection release request, where the connection release request is configured to indicate that the feeder link is about to be disconnected.

In some embodiments, the first core network device is configured to generate a notification message according to a UCU program or a UPU program, where the notification message is configured to indicate that the feeder link is about to be disconnected; and send the notification message to the UE through the access network device.

In some embodiments, the first core network device is further configured to receive an acknowledgement message sent by the UE through the access network device; send a first connection release instruction to the access network device, where the first connection release instruction is configured to indicate to maintain an RRC connection between the access network device and the UE, and the acknowledgement message carries indication information indicating that the UE determines to continue to reside in the current network; and notify a second core network device and/or a third core network device to enable a caching function for downlink data associated with the UE.

In some embodiments, the first core network device is further configured to receive an acknowledgement message sent by the UE through the access network device; perform deregistration on the UE based on a received deregistration request of the UE, where the acknowledgement message does not carry indication information indicating that the UE determines to continue to reside in the current network; send a second connection release instruction to the access network device, where the second connection release instruction is configured to indicate to release the RRC connection between the access network device and the UE; and release a connection with the second core network device, and notify the second core network device and the third core network device to release a connection between the second core network device and the third core network device.

In some embodiments, the first core network device is an access and mobility management function (AMF), the second core network device is a session management function (SMF), and the third core network device is a user plane function (UPF).

In some embodiments, the UE is configured to obtain a feeder link disconnection duration indicated by the feeder link information, when receiving the feeder link information sent by the first core network device through the access network device; and determine, according to the feeder link disconnection duration and a current service type of the UE, whether the UE continues to reside in the current network or accesses another network.

In some embodiments, the UE is configured to receive a notification message sent by the first core network device through the access network device, where the notification message is configured to indicate that the feeder link is about to be disconnected; and return an acknowledgement message carrying the indication information indicating that the UE determines to continue to reside in the current network through the access network device, when it is determined that the UE continues to reside in the current network.

In some embodiments, the UE is configured to receive a notification message sent by the first core network device through the access network device, where the notification message is configured to indicate that the feeder link is about to be disconnected; return an acknowledgement message through the access network device and send a deregistration request to the first core network device, when it is determined that the UE accesses another network; and select a radio access network and a core network that support access of the UE and initiate registration, when a deregistration is completed.

In some embodiments, the UE is configured to receive a notification message sent by the first core network device through the access network device, where the notification message is configured to indicate that the feeder link is about to be disconnected; and initiate switching to a radio access network and a core network that support access of the UE, when it is determined that the UE accesses another network.

In some embodiments, the UE is configured to receive the feeder link information sent by the access network device through a broadcast message.

In some embodiments, the access network device is configured to send feeder link information to the first core network device through a connection release request; and release a connection with the first core network device and maintain an RRC connection with the UE when a first connection release instruction sent by the first core network device is received, where the first connection release instruction is an instruction sent by the first core network device when the UE determines to continue to reside in the current network.

In some embodiments, the access network device is further configured to: cache uplink data associated with the UE, when the feeder link is disconnected; and send the cached uplink data, when the feeder link is reconnected.

In some embodiments, the access network device is further configured to: release the connection with the first core network device and release the RRC connection with the UE when a second connection release instruction sent by the first core network device is received, where the second connection release instruction is an instruction sent by the first core network device when the UE determines to access another network.

In some embodiments, the access network device is configured to send the feeder link information to the UE through a broadcast message.

As shown in FIG. 11, an embodiment of the present disclosure provides a first communication control device 10. The first communication control device 10 includes a first receiving unit 110 and a first sending unit 120.

The first receiving unit 110 is configured to obtain feeder link information, when a feeder link is about to be disconnected.

The first sending unit 120 is configured to send the feeder link information to a UE, where the feeder link information is configured to determine whether the UE continues to reside in a current network or accesses another network.

In some embodiments, the first receiving unit 110 is configured to: receive the feeder link information sent by the access network device.

In some embodiments, the first receiving unit 110 is configured to: receive the feeder link information sent by the access network device through a connection release request, where the connection release request is configured to indicate that the feeder link is about to be disconnected.

In some embodiments, the first sending unit 120 is further configured to: notify the UE that the feeder link is about to be disconnected.

In some embodiments, the first sending unit 120 is configured to: generate a notification message according to a UE configuration update (UCU) program or a UE parameter update (UPU) program, where the notification message is configured to indicate that the feeder link is about to be disconnected; and send the notification message to the UE through the access network device.

In some embodiments, the first sending unit 120 is further configured to: receive an acknowledgement message sent by the UE through the access network device; send a first connection release instruction to the access network device, where the first connection release instruction is configured to indicate to maintain a radio resource control (RRC) connection between the access network device and the UE, and the acknowledgement message carries indication information indicating that the UE determines to continue to reside in the current network; and notify a second core network device and/or a third core network device to enable a caching function for downlink data associated with the UE.

In some embodiments, the first sending unit 120 is further configured to: receive an acknowledgement message sent by the UE through the access network device; perform deregistration on the UE based on a received deregistration request of the UE, where the acknowledgement message does not carry indication information indicating that the UE determines to continue to reside in the current network; send a second connection release instruction to the access network device, where the second connection release instruction is configured to indicate to release the RRC connection between the access network device and the UE; and release a connection with the second core network device, and notify the second core network device and the third core network device to release a connection between the second core network device and the third core network device.

In some embodiments, the first core network device is an access and mobility management function (AMF), the second core network device is a session management function (SMF), and the third core network device is a user plane function (UPF).

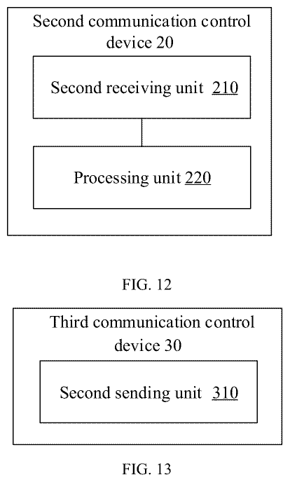

As shown in FIG. 12, an embodiment of the present disclosure provides a second communication control device 20. The second communication control device 20 includes a second receiving unit 210 and a processing unit 220.

The second receiving unit 210 is configured to receive feeder link information, when a feeder link is about to be disconnected.

The processing unit 220 is configured to determine, according to the feeder link information, whether to continue to reside in the current network or access another network.

In some embodiments, the processing unit 220 is configured to: obtain a feeder link disconnection duration indicated by the feeder link information, when receiving the feeder link information sent by the first core network device through the access network device; and determine, according to the feeder link disconnection duration and a current service type of the UE, whether the UE continues to reside in the current network or accesses another network.

In some embodiments, the processing unit 220 is further configured to: receive a notification message sent by the first core network device through the access network device, where the notification message is configured to indicate that the feeder link is about to be disconnected; and return an acknowledgement message carrying the indication information indicating that the UE determines to continue to reside in the current network through the access network device, when it is determined that the UE continues to reside in the current network.

In some embodiments, the processing unit 220 is further configured to: receive a notification message sent by the first core network device through the access network device, where the notification message is configured to indicate that the feeder link is about to be disconnected; return an acknowledgement message through the access network device and send a deregistration request to the first core network device, when it is determined that the UE accesses another network; and select a radio access network and a core network that support access of the UE and initiate registration, when a deregistration is completed.

In some embodiments, the processing unit 220 is further configured to: receive a notification message sent by the first core network device through the access network device, where the notification message is configured to indicate that the feeder link is about to be disconnected; and initiate switching to a radio access network and a core network that support access of the UE access, when it is determined that the UE accesses another network.

In some embodiments, the second receiving unit 210 is configured to: receive the feeder link information sent by the access network device through a broadcast message.

As shown in FIG. 13, an embodiment of the present disclosure provides a third communication control device 30. The third communication control device 30 includes: a second sending unit 310, configured to send feeder link information, when detecting that a feeder link is about to be disconnected, where the feeder link information is configured to determine whether a UE continues to reside in a current network or accesses another network.

In some embodiments, the second sending unit 310 is configured to: send the feeder link information to the first core network device through a connection release request; and release a connection with the first core network device and maintain an RRC connection with the UE when a first connection release instruction sent by the first core network device is received, where the first connection release instruction is an instruction sent by the first core network device when the UE determines to continue to reside in the current network.

In some embodiments, the second sending unit 310 is further configured to: cache uplink data associated with the UE, when the feeder link is disconnected; and send the cached uplink data, when the feeder link is reconnected.

In some embodiments, the second sending unit 310 is further configured to: release the connection with the first core network device and release the RRC connection with the UE when a second connection release instruction sent by the first core network device is received, where the second connection release instruction is an instruction sent by the first core network device when the UE determines to access another network.

In some embodiments, the second sending unit 310 is configured to: send the feeder link information to the UE through a broadcast message.

An embodiment of the present disclosure provides a communication device. The communication device includes:
a memory that stores processor executable instruction; and one or more processors, connected to the memory, where the one or more processors are collectively configured to perform the communication control method provided in any of the aforementioned technical solutions.

The processor may include various types of storage medium, which are non-transitory computer storage medium, and may continue to memory the information stored therein after the communication device is powered down.

Here, the communication device includes a terminal or a network element.

The processor may be connected to the memory through a bus or the like for reading the executable program stored in the memory, for example, in at least one of the methods shown in FIG. 2, and FIGS. 4 to 10.

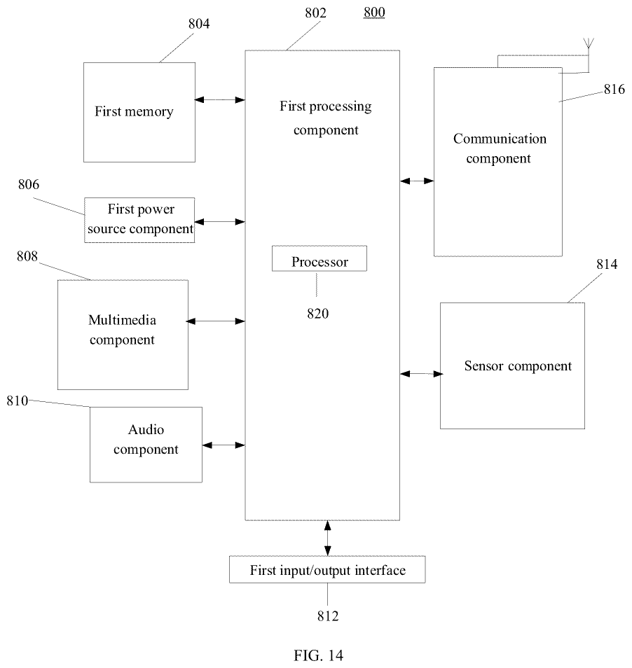

FIG. 14 is a block diagram of a second terminal 800 according to an example. For example, the second terminal 800 may be a mobile phone, a computer, a digital broadcast user equipment, a message transceiving device, a game console, a tablet device, a medical device, a fitness device, a personal digital assistant, or the like.

Referring to FIG. 14, the second terminal 800 may include one or more of the following components: a first processing component 802, a first memory 804, a first power source component 806, a multimedia component 808, an audio component 810, a first input/output (I/O) interface 812, a sensor component 814, and a communication component 816.

The first processing component 802 generally controls the overall operation of the second terminal 800, such as operations associated with display, telephone call, data communication, camera operation and recording operation. The first processing component 802 may include one or more processors 820 to execute instructions so as to generate all or some of the steps of the methods. In addition, the first processing component 802 may include one or more modules to facilitate interaction between the first processing component 802 and other components. For example, the first processing component 802 may include a multimedia module to facilitate interaction between the multimedia component 808 and the first processing component 802.

The first memory 804 is configured to store various types of data to support an operation on the second terminal 800. Examples of these data include instructions for any application program or method for operation on the second terminal 800, contact data, telephone directory data, messages, pictures, videos, or the like. The first memory 804 may be implemented by all types of volatile or non-volatile storage devices or combinations of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or a compact disc.

The first power source component 806 provides power for various components of the second terminal 800. The first power source component 806 may include a power source management system, one or more power sources, and other components associated with generating, managing and distributing power for the second terminal 800.

The multimedia component 808 includes a screen which provides an output interface between the second terminal 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding, and a gesture on the touch panel. The touch sensor may not only sense the boundary of the touch or sliding action, but also measure a duration and pressure related to the touch or sliding operation. In some embodiments, the multimedia component 808 includes a front-facing camera and/or a rear-facing camera. When the second terminal 800 is in an operation mode, such as a shooting mode or a video mode, the front-facing camera and/or the rear-facing camera may receive external multimedia data. Each of the front-facing camera and the rear-facing camera may be a fixed optical lens system or have focal length and optical zoom capability.

The audio component 810 is configured to output and/or input an audio signal. For example, the audio component 810 includes a microphone (MIC) configured to receive an external audio signal when the second terminal 800 is in an operation mode, such as a call mode, a recording mode, or a speech recognition mode. The received audio signal may be further stored in the first memory 804 or sent via the communication component 816. In some embodiments, the audio component 810 further includes a speaker for outputting the audio signal.

The first I/O interface 812 provides an interface between the first processing component 802 and peripheral interface modules which may be keyboards, click wheels, buttons, or the like. These buttons may include, but are not limited to, a home button, a volume button, a start button, and a lock button.

The sensor component 814 includes one or more sensors configured to provide state evaluation of various aspects for the second terminal 800. For example, the sensor component 814 may detect an on/off state of the second terminal 800, and relative positioning of components, for example, the component is a display and a keypad of the second terminal 800. The sensor component 814 may also detect a position change of the second terminal 800 or a component of the second terminal 800, the presence or absence of contact between the user and the second terminal 800, the orientation or acceleration/deceleration of the second terminal 800, and the temperature change of the second terminal 800. The sensor component 814 may include a proximity sensor configured to detect the presence of a nearby object without any physical contact. The sensor component 814 may further include an optical sensor, such as a CMOS or CCD image sensor, used in imaging applications. In some embodiments, the sensor component 814 may further include an acceleration sensor, a gyro sensor, a magnetic sensor, a pressure sensor, or a temperature sensor.

The communication component 816 is configured to facilitate wired or wireless communication between the second terminal 800 and other devices. The second terminal 800 may access a communication standard-based wireless network, such as WiFi, 2G or 3G, or a combination of them. In an example, the communication component 816 receives a broadcast signal or broadcast related information from an external broadcast management system via a broadcast channel. In an example, the communication component 816 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the second terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the methods.

In an example, a non-transitory computer-readable storage medium including instructions, such as the first memory 804 including instructions, is further provided. The instructions may be executed by the processor 820 of the second terminal 800 to generate the methods. For example, the non-transitory computer-readable storage medium may be an ROM, a random access memory (RAM), a CD-ROM, a magnetic tape, a floppy disk, an optical data storage device, or the like.

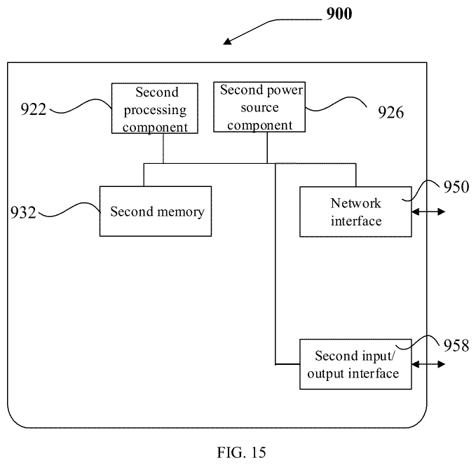

As shown in FIG. 15, an embodiment of the present disclosure shows a structural schematic diagram of a communication device 900. For example, the communication device 900 may be provided as a network-side device. The communication device 900 may be the aforementioned base station.

Referring to FIG. 15, the communication device 900 includes a second processing component 922, and further includes one or more processors, and a memory resource represented by a second memory 932, configured to store instructions capable of being executed by the second processing component 922, such as an application. The application stored in the second memory 932 may include one or more modules each corresponding to a set of instructions. In addition, the second processing component 922 is configured to execute instructions so as to execute any of the methods applied to the base station, e.g., at least one of the methods shown in FIG. 2, and FIGS. 4 to 10.

The communication device 900 may further include a second power source component 926 configured to perform power source management of the communication device 900, a wired or wireless network interface 950 configured to connect the communication device 900 to a network, and a second input/output (I/O) interface 958. The communication device 900 may operate based on an operating system stored in the second memory 932, such as Windows Server™, Mac OS XTM, Unix™, Linux™, FreeBSD™, or the like.

Those skilled in the art will be readily conceivable of other implementation solutions of the present disclosure after considering the description and practicing the present disclosure disclosed herein. The present disclosure is intended to cover all variations, uses or adaptive changes of the present disclosure, which follow the general principles of the present disclosure and include common general knowledge or customary technical means in the technical field that is not disclosed in the present disclosure. The description and embodiments are considered to be illustrative, and the true scope and spirit of the present disclosure are indicated by the following claims.

It is to be understood that the present disclosure is not limited to a precise structure described and shown in the accompanying drawings, and various modifications and changes can be made without departing from the scope of the present disclosure. The scope of the present disclosure is limited by the appended claims.

1. A communication control method, performed by a first core network device, the method comprising:
obtaining feeder link information, in a case where a feeder link is about to be disconnected; and
sending the feeder link information to a user equipment (UE) through an access network device, wherein the feeder link information is configured to determine whether the UE continues to reside in a current network or accesses another network.

2. The method according to claim 1, wherein obtaining the feeder link information comprises:
receiving the feeder link information sent by the access network device.

3. The method according to claim 2, wherein receiving the feeder link information sent by the access network device comprises:
receiving the feeder link information sent by the access network device through a connection release request, wherein the connection release request is configured to indicate that the feeder link is about to be disconnected.

4. The method according to claim 1, wherein the method further comprises:
notifying the UE that the feeder link is about to be disconnected.

5. The method according to claim 4, wherein notifying the UE that the feeder link is about to be disconnected comprises:
generating a notification message according to a UE configuration update (UCU) program or a UE parameter update (UPU) program, wherein the notification message is configured to indicate that the feeder link is about to be disconnected; and
sending the notification message to the UE through the access network device.

6. The method according to claim 4, wherein the method further comprises:
receiving an acknowledgement message sent by the UE through the access network device;
sending a first connection release instruction to the access network device, wherein the first connection release instruction is configured to indicate to maintain a radio resource control (RRC) connection between the access network device and the UE, and the acknowledgement message carries indication information indicating that the UE determines to continue to reside in the current network; and
notifying at least one of a second core network device or a third core network device to enable a caching function for downlink data associated with the UE.

7. The method according to claim 4, wherein the method further comprises:
receiving an acknowledgement message sent by the UE through the access network device;
performing deregistration on the UE based on a received deregistration request of the UE, wherein the acknowledgement message does not carry indication information indicating that the UE determines to continue to reside in the current network;
sending a second connection release instruction to the access network device, wherein the second connection release instruction is configured to indicate to release RRC connection between the access network device and the UE;
releasing a connection with a second core network device; and
notifying the second core network device and a third core network device to release a connection between the second core network device and the third core network device.

8. The method according to claim 6, wherein the first core network device is an access and mobility management function (AMF), the second core network device is a session management function (SMF), and the third core network device is a user plane function (UPF).

9. A communication control method, performed by a user equipment (UE), the method comprising:
receiving feeder link information, in a case where a feeder link is about to be disconnected; and
determining, according to the feeder link information, whether to continue to reside in a current network or access another network.

10. The method according to claim 9, wherein determining, according to the feeder link information, whether to continue to reside in the current network or access another network comprises:
obtaining a feeder link disconnection duration indicated by the feeder link information when the feeder link information sent by a first core network device is received through an access network device; and
determining, according to the feeder link disconnection duration and a current service type of the UE, whether the UE continues to reside in the current network or accesses another network.

11. The method according to claim 10, wherein the method further comprises:
receiving a notification message sent by the first core network device through the access network device, wherein the notification message is configured to indicate that the feeder link is about to be disconnected; and
returning an acknowledgement message carrying indication information indicating that the UE determines to continue to reside in the current network through the access network device, in response to determining that the UE continues to reside in the current network.

12. The method according to claim 10, wherein the method further comprises:
receiving a notification message sent by the first core network device through the access network device, wherein the notification message is configured to indicate that the feeder link is about to be disconnected;
returning an acknowledgement message through the access network device and sending a deregistration request to the first core network device, in response to determining that the UE accesses another network; and
selecting a radio access network and a core network that support access of the UE and initiating registration, in a case where a deregistration is completed.

13. The method according to claim 10, wherein the method further comprises:
receiving a notification message sent by the first core network device through the access network device, wherein the notification message is configured to indicate that the feeder link is about to be disconnected; and
initiating switching to a radio access network and a core network that support access of the UE, in response to determining that the UE accesses another network.

14. The method according to claim 9, wherein receiving the feeder link information comprises:
receiving the feeder link information sent by an access network device through a broadcast message.

15. A communication control method, performed by an access network device, the method comprising:
sending feeder link information, in response to detecting that a feeder link is about to be disconnected, wherein the feeder link information is configured to determine whether a user equipment (UE) continues to reside in a current network or accesses another network.

16. The method according to claim 15, wherein sending the feeder link information comprises:
sending the feeder link information to a first core network device through a connection release request;
wherein the method further comprises:
releasing a connection with the first core network device and maintaining an RRC connection with the UE when a first connection release instruction sent by the first core network device is received, wherein the first connection release instruction is an instruction sent by the first core network device in response to determining that the UE continues to reside in the current network.

17. The method according to claim 16, wherein the method further comprises:
caching uplink data associated with the UE, in a case where the feeder link is disconnected; and
sending the cached uplink data, in a case where the feeder link is reconnected.

18. The method according to claim 16, wherein the method further comprises:
releasing the connection with the first core network device and releasing the RRC connection with the UE when a second connection release instruction sent by the first core network device is received, wherein the second connection release instruction is an instruction sent by the first core network device in response to determining that the UE accesses another network.

19. The method according to claim 15, wherein sending the feeder link information comprises:
sending the feeder link information to the UE through a broadcast message.

20.-23. (canceled)

24. A communication device, comprising: one or more processors; a memory that stores an executable program that is runnable by the processor, wherein the one or more processors are collectively configured to, when running the executable program, performs the method according to claim 1.

25. (canceled)
